(19) United States
(12) Patent Application Publication
(10) Pub. No.: US 2014/0002216 A1
(43) Pub. Date: Jan. 2, 2014

(54) MINI HIGH-POWER MAGNETIC LATCHING RELAY

(71) Applicant: NINGBO FORWARD RELAY CORP. LTD, Ningbo (CN)

(72) Inventors: Xiaoxia Yang, Ningbo (CN); Guozhang Gao, Ningbo (CN); Shuijun Wang, Ningbo (CN)

(21) Appl. No.: 13/837,886

(22) Filed: Mar. 15, 2013

(30) Foreign Application Priority Data
Jul. 2, 2012 (CN) 201220321280.2

(51) Int. Cl. H01H 50/18

(52) U.S. Cl. CPC H01H 50/18
USPC 335/185

(57) ABSTRACT

A mini high-power magnetic latching relay containing a magnetic circuit is compact in structure, which can minimize the overall volume of the relay to facilitate application to the printed circuit board requiring high power and small volume of relay, and expansion of the application scope of magnetic latching relay is provided by this invention. The magnetic circuit comprises a magnetic enclosure, an iron core, a winding; the winding comprises a coil former and a coil wrapped on the coil former. The magnetic enclosure is formed by a magnetic steel and armature vertically located on both ends of the magnetic steel. This structure provides a balanced magnetic circuit that can ensure contact pressure in the magnetic latching relay, stable bouncing time, and improved service life.

### CROSS-REFERENCE TO RELATED APPLICATION

This application claims the benefit of priority under 35 U.S.C. §119 from Chinese Patent Application Number 20122.00321280.2 filed on Jul. 2, 2012, now Patent No. CN 20265099 U granted on Jan. 2, 2013, the contents of which is hereby incorporated by reference in its entirety.

### FIELD OF THE INVENTION

This invention relates generally to electrical relays, and more specifically to a mini high-power magnetic latching relay.

### BACKGROUND OF THE INVENTION

Accompanied by extensive applications, more relays of different functions and structures have come into being, wherein electromagnetic relays and magnetic latching relays are the most common ones. A magnetic latching relay is a pulse-driven relay, which is available for self latching upon de-excitation of a coil (disappearance of pulse). However, most magnetic latching relays in the market are big in overall structure and unlikely to be used on printed circuit boards, thereby limiting the application scope of magnetic latching relays.

### SUMMARY OF THE INVENTION

The technical issue to be solved by this invention is to provide a mini high-power magnetic latching relay of high load and small volume.

The invention provides the following solution to solve the aforesaid technical issue: A mini high-power magnetic latching relay, comprising a shield, a base seat, an insulation sleeve, a push rod, a magnetic circuit and a contact part. The magnetic circuit comprises a magnetic enclosure, an iron core, a yoke and a winding. The winding comprises a coil former and a coil wrapped on the said coil former. One end of the said yoke is a U-shaped end. Whereas the iron core penetrates through the coil for fixed connection with another end of the yoke; the end of the yoke is located at the center of the U-shaped end of the yoke to form an E shape. The magnetic enclosure is formed by the magnetic steel and the armature vertically located on both ends of the magnetic steel through injection. The shaft of the magnetic enclosure is connected to the coil former. The two armatures and the magnetic steel are formed into a U shape. The two armatures are collaterally inserted into the E-shaped gap formed by the iron core and the said yoke for proper alignment.

The contact part comprises a dynamic contact pair and a static contact pair inserted into the said base seat. The dynamic contact pair comprises a dynamic contact clip and a dynamic contact point. One end of the push rod is connected with the magnetic enclosure; another end of the said push rod is connected with the dynamic contact clip.

The push rod comprises a push seat and two push arms integrated with the push seat. The push seat is tapped with a mounting hole. The magnetic enclosure is integrated with a push shaft. The push shaft is inserted into the mounting hole. The upper part of the insulation sleeve is provided with two push grooves with position corresponding to that of the push arm. The push arm penetrates through the push groove. The end of the push arm is provided with two opposite slots. The upper part of the dynamic contact clip is provided with two U-notches with position corresponding to that of the push arm. The part of the said dynamic contact clip located on both sides of the U-notches is clamped into the slots to ensure stable pushing of the dynamic contact clip by the push rod, and prevents the end of push arm from disengagement from notches on the dynamic contact clip.

The coil former comprises a hollowed cylindrical shaft. The cylindrical shaft is located inside the insulation sleeve. The insulation sleeve is fixed and installed on the said base seat. One end of the cylindrical shaft is provided with a back plate. Another end of the said cylindrical shaft is provided with a connecting plate. The coil is wrapped on the cylindrical shaft, The iron core penetrates through the cylindrical shaft for riveting with the yoke. The back plate is located on the inner side of another end of the yoke. A side wall is integrated on both sides of the said connecting plate. The side wall is provided with a connecting hole. The magnetic enclosure is integrated with a coupling shaft. The coupling shaft is installed inside the connecting hole. The lower end of the connecting plate is integrated with a base plate. A slot is provided between the side wall and the base plate for insert of U-shaped end of the said yoke.

A chute that can facilitate installation of the magnetic enclosure on the coupling shaft is provided inside the side wall.

A positioning slot is integrated on both sides of lower end of the insulation sleeve, respectively. The base seat is integrated with a positioning block. The positioning slot is coupled with the positioning block.

One side of the magnetic enclosure as opposite to the armature is thick at the center and thin on both ends.

As compared with the prior art, the magnetic latching relay of the present invention is characterized in that the magnetic circuit part of this relay is compact in structure, which can minimize the overall volume of the relay to enable its application to the printed circuit board requiring a small sized relay and extension of the application field of the magnetic latching relay. Furthermore, the magnetic circuit part is in the structure of a balanced magnetic circuit that can ensure contact pressure of the magnetic latching relay, stable bouncing time and improved service life of the relay; moreover, as a slot used to insert the U-shaped end of the yoke is provided between the side wall of the coil former and the base plate, both side walls of the coil former in this structure are provided with elasticity, which can facilitate installation of magnetic enclosure to ensure more compact structure of the whole relay and reduced volume.

### BRIEF DESCRIPTION OF THE DRAWING

In the accompanying drawings:

FIG. 1 is a perspective view of the mini high power magnetic latching relay of the present invention without its shield.

FIG. 2 is a side view of the magnetic circuit portion of the magnetic latching relay.

FIG. 3 is an exploded perspective view of the magnetic latching relay of FIG. 1.

FIG. 4 is a perspective view of the coil former of the magnetic latching relay.

FIG. 5 is a perspective view of the insulation sleeve of the magnetic latching relay.

### DETAILED DESCRIPTION OF THE PREFERRED EMBODIMENTS

A detailed description of the structure of the preferred embodiments of the mini high power magnetic latching relay of the present invention is stated as follows:

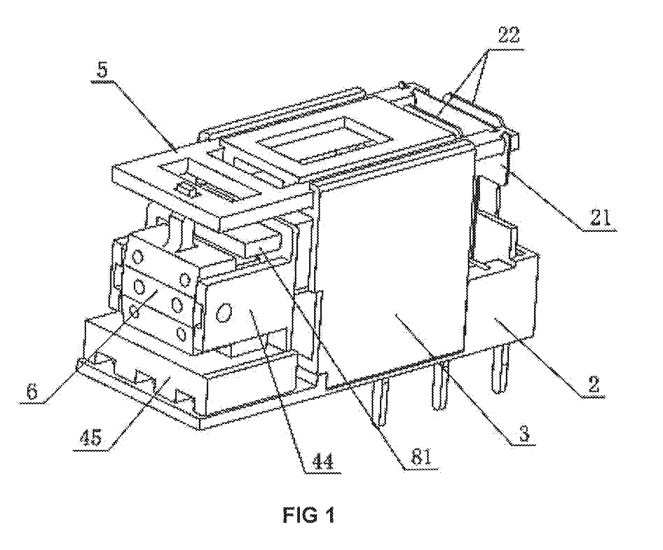

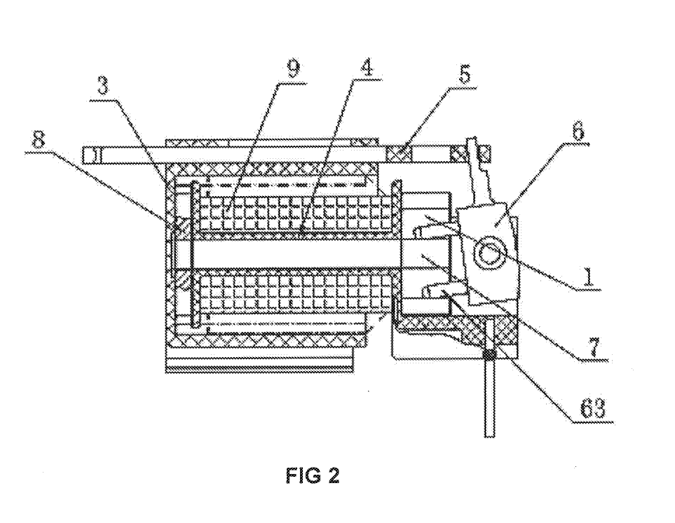

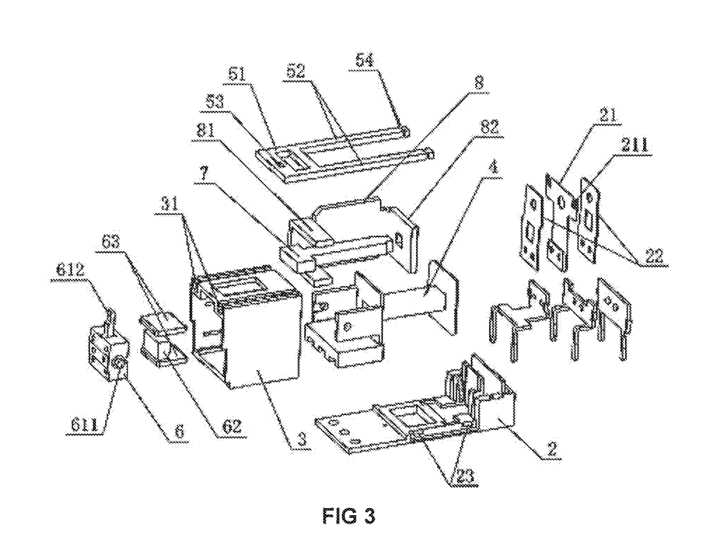

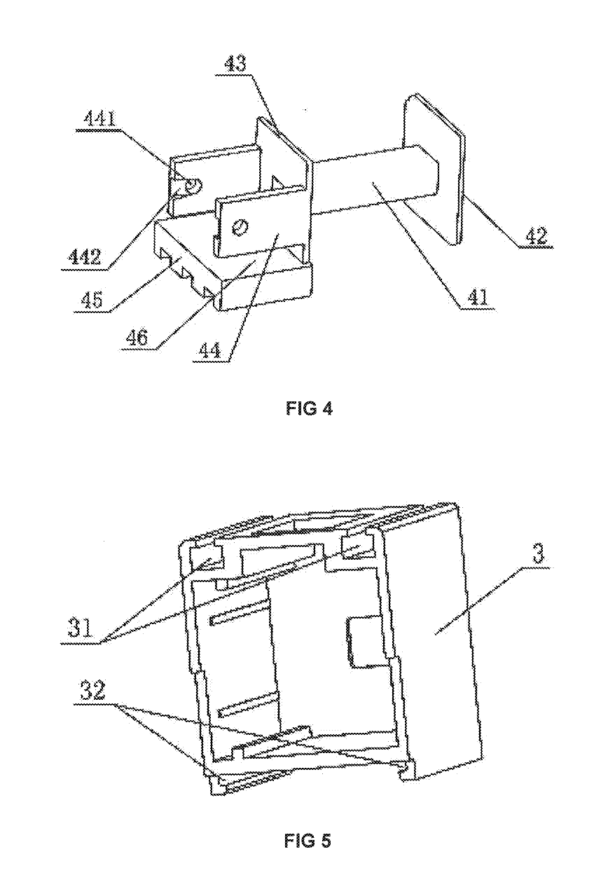

A mini high-power magnetic latching relay as shown in FIGS. 1-5, comprises a shield. (not illustrated), a base seat 2, an insulation sleeve 3, a push rod 5, and a magnetic circuit and a contact part. The magnetic circuit comprises a magnetic enclosure 6, an iron core 7, a yoke 8 and a winding. The winding comprises a coil former 4 and a coil 9 wrapped around the said coil former 4.

The coil former 4 comprises a hollowed cylindrical shaft 41. This cylindrical shaft 41 is located inside the insulation sleeve 3. One end of the cylindrical shaft 41 is provided with a back plate 42. Another end of the cylindrical shaft 41 is provided with a connecting plate 43. The coil 9 is wrapped around the cylindrical shaft 41. One end of the yoke 8 belongs to U-shaped end 81. The iron core penetrates through the cylindrical shaft 41 for riveting with another end 82 of the yoke. Back plate 42 is located inside another end 82 of the yoke 8. The end of iron core 7 is located at the center of U-shaped end 81 of the yoke 8 to form an E shape with U-shaped end 81. A side wall 44 of coil Mailer 4 is integrated on both sides of the connecting plate 43, respectively. The lower end of the connecting plate 43 is integrated with a base plate 45. A slot 46 used to insert U-shaped end 81 of the yoke 8 is provided between the side wall 44 and the base plate 45. A connecting hole 441 is provided on the side wall 44.

Magnetic enclosure 6 comprises a magnetic steel 62 and an armature 63 vertically located on both ends of the magnetic steel 62, respectively, through injection. Two armatures 63 and the magnetic steel 62 are formed into a U shape. The two armatures 63 are collaterally inserted into the gap 1 that is formed by the iron core 7 and the yoke 8 for proper alignment. One side of the magnetic enclosure 6 opposite to the armature 63 is thick at the center and thin on both ends. The magnetic enclosure 6 is integrated with a coupling shaft 611. The coupling shaft 611 is installed inside the connecting hole 441 of the coil former 4. A chute 442 that can facilitate installation of the coupling shaft 611 is provided inside the side wall 44.

The contact part comprises a dynamic and static contact pairs 22 as inserted into the base seat 2. The dynamic contact pair comprises a dynamic contact clip 21 and a dynamic contact point (not illustrated). Push rod 5 comprises a push seat 51 and two push arms 52 as integrated with the push seat 51. The push seat 51 is provided with a mounting hole 53.

The magnetic enclosure 6 is integrated with a push shaft 612. The push shaft 612 is inserted into the mounting hole 53 of push rod 5. The upper end of the insulation sleeve 3 is provided with a push groove 31 with position corresponding to the push arm 52 of push rod 5. The push arm 52 penetrates through the push groove 31, The end of push arm 52 is provided with two opposite slots 54. The upper end of the dynamic contact clip 21 is provided with two U-notches 211 corresponding to the push arm 52. The part of dynamic contact clip 21 located on both sides of the two U-notches 211 is inserted into the slot 54. A positioning slot 32 is integrated on both sides of the lower end of the insulation sleeve 3, respectively, A positioning block 23 is integrated on the base seat 2. Positioning slot 32 is clamped to the positioning block 23.

What is claimed is:

1. A mini high-power magnetic latching relay, comprising a shield, a base seat, an insulation sleeve, a push rod, a magnetic circuit and a contact part, which is characterized in that the said magnetic circuit comprises a magnetic enclosure, an iron core, a yoke and a winding; the said winding comprises a coil former and a coil wrapped on the said coil former; one end of the said yoke is a U-shape end; whereas the said iron core penetrates through the said coil for fixed connection with another end of the said yoke; the end of the said yoke is located at the center of U-shape end of the said yoke to form a E shape; the said magnetic enclosure is formed by the said magnetic steel and the said armature vertically located on both ends of the said magnetic steel through injection; shaft of the said magnetic enclosure is connected to the said coil former; the two armatures and the said magnetic steel are formed into a U shape; the two armatures are collaterally inserted into the E-shape gap as formed by the said iron core and the said yoke for alignment.

2. The mini high-power magnetic latching relay according to claim 1, characterized in that the said contact part comprises a dynamic contact pair and a static contact pair inserted into the said base seat; the said dynamic contact pair comprises a dynamic contact clip and a dynamic contact point; one end of the said push rod is connected with the said magnetic enclosure; another end of the said push rod is connected with the said dynamic contact clip.

3. The mini high-power magnetic latching relay according to claim 2, characterized in that the said push rod comprises a push seat and two push arms integrated with the said push seat; the said push seat is tapped with a mounting hole; the said magnetic enclosure is integrated with a push shaft; the said push shaft is inserted into the said mounting hole; upper part of the said insulation sleeve is provided with two push grooves with position corresponding to that of the said push arm; the said push arm penetrates through the said push groove; the end of the said push arm is provided with two opposite slots; upper part of the said dynamic contact clip is provided with two U-notches with position corresponding to that of the said push arm; the part of the said dynamic contact clip as located on both sides of the said U-notches is clamped into the said slots.

4. The mini high-power magnetic latching relay according to claim 1, characterized in that the said coil former comprises a hollowed cylindrical shaft; the said cylindrical shaft is located inside the said insulation sleeve; the said insulation sleeve is fixed and installed on the said base seat; one end of the said cylindrical shaft is provided with a back plate; another end of the said cylindrical shaft is provided with a connecting plate; the said coil is wrapped on the said cylindrical shaft; the said iron core penetrates through the said cylindrical shaft for riveting with the said yoke; the said back plate is located on the inner side of another end of the said yoke; a side wall is integrated on both sides of the said connecting plate; the said side wall is provided with a connecting hole; the said magnetic enclosure is integrated with a coupling shaft; the said coupling shaft is installed inside the said connecting hole; lower end of the said connecting plate is integrated with a base plate; a slot is provided between the said side wall and the said base plate for insert of U-shape end of the said yoke.

5. The mini high-power magnetic latching relay according to claim 4, characterized in that a chute that can facilitate installation of the said magnetic enclosure on the coupling shaft is provided inside the said side wall.

6. The mini high-power magnetic latching relay according to claim 1, characterized in that a positioning slot is integrated on both sides of lower end of the said insulation sleeve respectively; the said base seat is integrated with a positioning block; the said positioning slot is coupled with the said positioning block.

7. The mini high-power magnetic latching relay according to claim 1, characterized in that one side of the said magnetic enclosure as opposite to the armature is thick at the center and thin on both ends.
